(19) United States
(12) Patent Application Publication
(10) Pub. No.: US 2008/0286439 A1
(43) Pub. Date: Nov. 20, 2008

(54) SUGAR-COATING PROCESS AND BAFFLES THEREFOR

(75) Inventors: Xiuying LIU, Glen Rock, NJ (US); Nizamuddin BAKSH, Paramus, NJ (US); Sheetal KULKARNI, Haskell, NJ (US); John KRESEVIC, New Windsor, NY (US); Robin ENEVER, New City, NY (US)

Correspondence Address: Pepper Hamilton LLP/Wyeth, 400 Berwyn Park, 899 Cassatt Road, Berwyn, PA, 19312-1183, US

(73) Assignee: WYETH, Madison, NJ (US)

(21) Appl. No.: 11/935,092

(22) Filed: Nov. 5, 2007

Related U.S. Application Data
(60) Provisional application No. 60/864,726, filed on Nov. 7, 2006.

(51) Int. Cl. B01J 13/22; A23G 3/26

(52) U.S. Cl. 427/2.18; 118/19

(57) ABSTRACT

This invention provides baffles (10) for use in coating pans (50) within coating apparatus, and methods of manufacturing the baffles (10). The invention further provides methods of coating pharmaceutical formulations using the baffles (10) and coating pans (50) of the present invention.

This application claims the benefit of priority of U.S. Provisional Appl. Ser. No. 60/864,726, filed Nov. 7, 2006, which is hereby incorporated by reference in its entirety.

### FIELD OF THE INVENTION

This invention relates to sugar coating processes, and baffles for use in coating apparati.

### BACKGROUND OF THE INVENTION

The sugar coating process originated within the confectionery industry. It is perhaps one of the oldest pharmaceutical processes for taste masking. Although sugar coating of tablets is less frequently employed, probably because of its level of coating expertise needed to achieve consistent elegant products, it has been retained by many companies worldwide because of many factors including, for example, inexpensive and readily available raw materials, global acceptance of raw materials (with exception of colors), highly elegant appearance of coated tablets, and suitable lower temperature for aqueous process and processing for heat sensitive products.

Although complex, the “basic” application procedures for sugar coating involve the following steps: 1) maintaining appropriate coating pan conditions throughout operations, such as air flow rate(s), humidity conditions, and bed temperature(s); 2) consistent multiple applications of an appropriate or titrated volume of coating solution/suspension to a cascading/flowing bed of tablets; 3) an appropriate tumbling jog cycle to allow distribution of the coating solution/suspension uniformly across the surface of each tablet in the charge; and 4) drying of each application of the coating solution/suspension to assure uniform distribution prior to the next application(s).

Factors for coating uniformity in the sugar coating process include, for example, application of sufficient coating medium to spread across the surface of every tablet in the batch, sufficiently fluidity of the coating medium to permit spreading across the surface of every tablet in the batch, and appropriate dimensions and shape of the coating pan and baffles to provide adequate mixing and avoid “dead spots” or, conversely, “wet spots.”

Suitable baffle designs exhibiting excellent mixing and coating uniformity would thus be highly desirable for coating pharmaceutical formulations.

### SUMMARY OF THE INVENTION

The present invention provides a baffle comprising: a first side comprising a top edge, a bottom edge, and a lateral edge, wherein the first side is flat, and wherein the top edge and bottom edge converge to form a first side tip that is distal to the lateral edge; and a second side comprising a top edge, a bottom edge, and a lateral edge, wherein the second side is curved, and wherein the top edge and bottom edge converge to form a second side tip that is distal to the lateral edge. The first side and second side of the baffle are joined at each of the top edges. In addition, joining of the first and second sides forms an internal angle of no less than about 45° to no greater than about 120°. Further, the first side tip and second side tip converge to form a single tip. In some embodiments, the first side and second side are joined seamlessly at the top edges.

Also provided in accordance with the present invention are coating pans comprising: a cylindrical surface for receiving a pharmaceutical formulation; an outer wall in contact with one end of the cylindrical surface; an inner wall in contact with the other end of the cylindrical surface; and at least one baffle as described above. The lateral edges of the first and second sides forming the baffle contact the inner or outer wall of the coating pan. In addition, the bottom edges of the first and second sides forming the baffle contact the cylindrical surface of the coating pan. In some embodiments, the single tip of at least one of the baffles in the coating pan does not extend the entire width of the cylindrical surface. In some embodiments, the coating pan comprises at least two baffles which are oriented in the opposite direction.

Also provided in accordance with the present invention are coating apparati comprising a coating pan described above.

Also provided in accordance with the present invention are methods of manufacturing a baffle comprising creating a template of the baffle, and cutting and shaping a baffle material based upon the template. In some embodiments, the contour of the coating pan is used to create the baffle template. In some embodiments, the template comprises a height of no less than about 1 inch and no greater than about 8 inches, and comprises a length that is no less than about 0.1 inch and no greater than about 4 inches less than the width of the cylindrical surface of the coating pan. In some embodiments, the internal angle of the baffle is about 90°. In some embodiments, the baffle material is Teflon™ which is shaped with a lathe.

Also provided in accordance with the present invention are methods of coating a pharmaceutical formulation comprising introducing the pharmaceutical formulation and coating composition into a coating pan described herein and rotating the coating pan. In some embodiments, the coating composition comprises at least one sugar.

### BRIEF DESCRIPTION OF THE DRAWINGS

FIG. 1 shows a representative baffle (10) of the invention.

FIG. 2 shows a cross-section of a representative baffle (10) of the invention.

FIG. 3 shows a representative baffle (10) within a representative coating pan (50) of the invention.

FIG. 4 shows placement of the baffles (10) in regard to the cylindrical surface (52) of a representative coating pan (50) of the invention.

FIG. 5 shows weight variations at different weight gain levels using different baffle designs.

FIG. 6 shows weight variations of coated tablets at different weight gain levels using different baffles.

FIG. 7 shows content uniformity of MPA of coated tablets at 100% weight gain level using different baffles.

FIG. 8 shows weight variations of coated tablets at different weight gain levels using different baffles coated in GCX1000 (the legend mirrors the order of the bars of the graph).

FIG. 9 shows content uniformity of MPA of coated tablets at 100% weight gain level using different baffles coated in GCX1000.

FIG. 10 shows Baffle A installed in a pan.

FIG. 11 shows Baffle B installed in a pan.

FIG. 12 shows Baffle C installed in a pan.

FIG. 13 shows Baffle B and Baffle D installed in a pan, wherein Baffle D is the baffle closest to the viewer.

FIG. 14 shows two views of Baffle E installed in a pan.

FIG. 15 shows Baffle F installed in a pan.

FIG. 16 shows Baffle G installed in a pan. Baffle G is an embodiment of the present invention.

FIG. 17 shows Baffle H installed in a pan.

FIG. 18 shows two views of Baffle I installed in a pan.

### DETAILED DESCRIPTION

In some embodiments, the invention provides a baffle (10). The baffle can be used, for example, in a variety of coating pans within any coating apparati for coating pharmaceutical formulations. Suitable formulations that can be coated using the baffle(s) of the invention include, but are not limited to, tablets and the like.

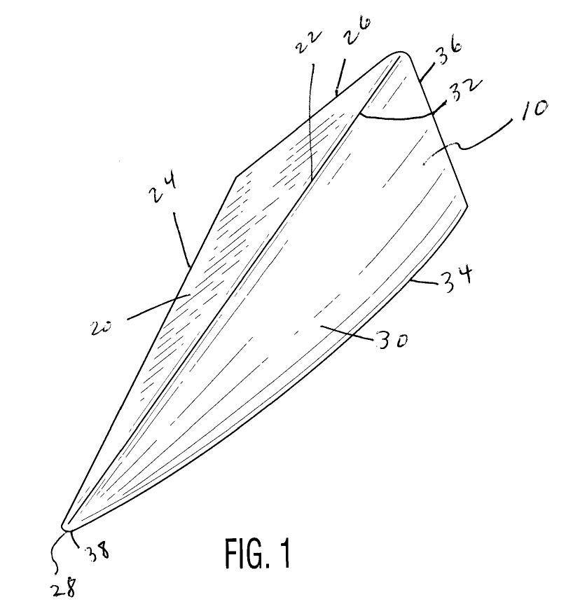

Referring to FIG. 1, the baffle (10) comprises a first side (20) and a second side (30). The first side (20) comprises three edges: a top edge (22), a bottom edge (24), and a lateral edge (26). The top edge (22) and bottom edge (24) of the first side (20) converge to form a first side tip (28) distal to the lateral edge (26) of the first side (20). In some embodiments, the first side (20) is flat (planar) and has no curvature.

Also referring to FIG. 1, the second side (30) also comprises three edges: a top edge (32), a bottom edge (34), and a lateral edge (36). The top edge (32) and bottom edge (34) of the second side (30) converge to form a second side tip (38) distal to the lateral edge (36) of the second side (30). In some embodiments, the second side (30) is curved in a convex manner from the lateral edge (36) to the second side tip (38).

Still referring to FIG. 1, the first side (20) and second side (30) are joined at each of the respective top edges (22) and (32), thus forming a single baffle unit (10) with the first side tip (28) converging with the second side tip (38). In some embodiments, the joining of the sides (20) and (30) can be accomplished by one or more fasteners (not shown) commonly used in the art. For example, the fasteners can be mechanical fasteners such as bolts, screws, hinges, rivets, and the like. In addition, the fasteners can include chemical agents such as glues, epoxys, and the like. Alternately, the joint formed by the first and second sides (20) and (30) can be seamless. Thus, in some embodiments, the first and second sides (20) and (30) can be manufactured as a single integral unit. In some embodiments, the edge (22/32) formed by the joining of the respective top edges of the first side and second side is rounded to enable tablets to roll more smoothly over the baffle.

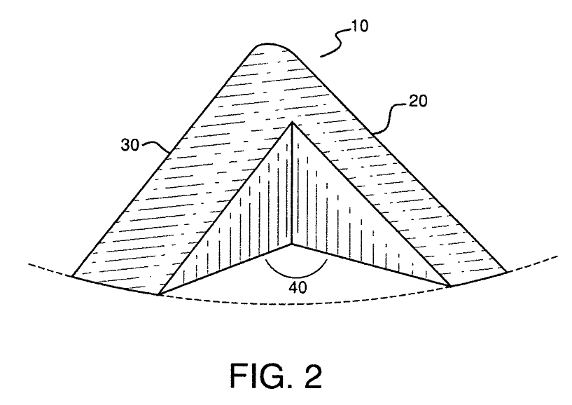

Referring to FIG. 2, the joining of the first and second sides (20) and (30) creates an internal angle (40) no less than about 45°, no less than about 50°, no less than about 55°, no less than about 60°, no less than about 65°, no less than about 70°, no less than about 75°, no less than about 80°, or no less than about 85°. The internal angle (40) formed by the first and second sides (20) and (30) is also no greater than about 120°, no greater than about 115°, no greater than about 110°, no greater than about 105°, no greater than about 100°, or no greater than about 95°. In some embodiments, the internal angle is about 90°. In this context, the term “about” means ±1°. Referring to FIG. 1, in some embodiments, the length of the baffle from first side tip (28) and/or second side tip (38) along top edges (22) and/or (32) is at least about 6 inches, at least about 8 inches, at least about 10 inches, at least about 12 inches, at least about 14 inches, at least about 16 inches, at least about 18 inches, at least about 20 inches, at least about 24 inches, or longer. In some embodiments, the length of the baffle from first side tip (28) and/or second side tip (38) along top edges (22) and/or (32) is selected such that the gap between the convergence of the first side tip (28) and the second side tip (38) and the end of the cylindrical surface (52) is as described below.

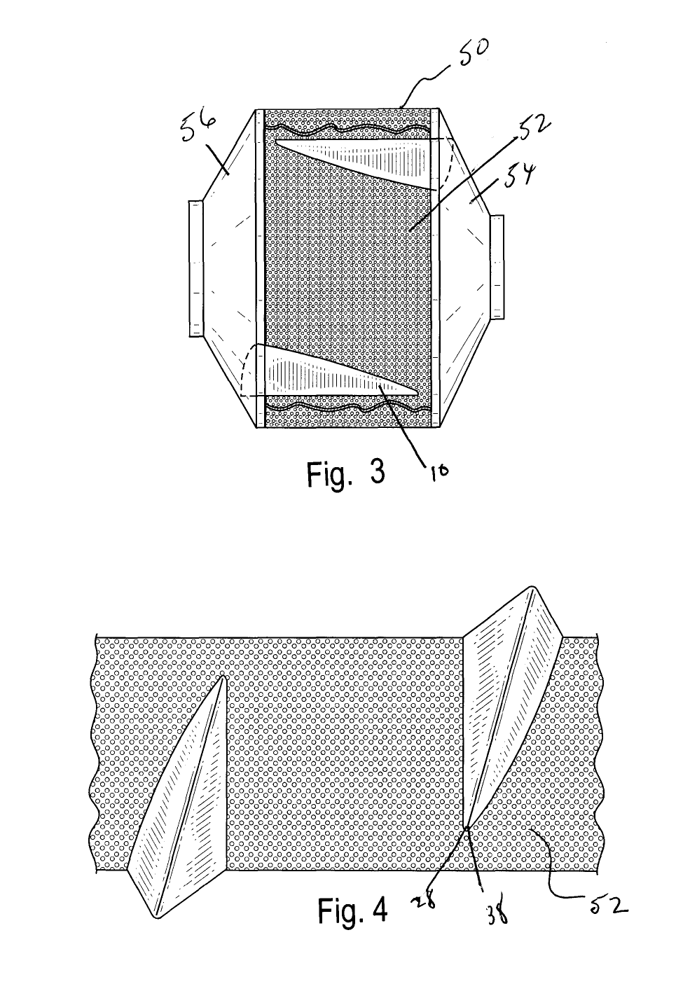

Also referring to FIG. 2, the height of the baffle (10) ranges from about 1 inch to about 8 inches, or from about 5 inches to about 8 inches, or from about 7 inches to about 8 inches, or from about 2 inches to about 4 inches. As used herein, the height of the baffle is the distance between the intersection of the lateral edge (26) and the lateral edge (36), and a surface point. As used herein, a surface point refers to a point on the surface which is midway between the point at which the lateral edge (26) intersects the surface and the point at which the lateral edge (36) intersects the surface, when the baffle is placed on the surface (for example, see FIG. 4). Referring to FIG. 3, in some embodiments, the height of the baffle (10) is about 3 inches. In some embodiments, the height of the baffle (10) is about 6.5 inches. In addition, baffle (10) comprises a length that is no less than about 1/16 inch, no less than about ½ inch, or no less than about 1 inch and no greater than about 4 inches, no greater than about 3 inches, or no greater than about 2 inches shorter than the width of the cylindrical surface (52) of the coating pan (50), thus leaving a gap between the single tip of the baffle (10) and the edge of the cylindrical surface (52) of the coating pan (50). In this context, the term “about” means ±¼ inch.

The sides (20) and (30) of baffle (10) can be perforated or non-perforated but are preferably non-perforated, and can be made of any material suitable for coating pharmaceutical formulations including, but not limited to, metals such as stainless steel, plastic, fiberglass, polytetrafluoroethylene (Teflon™), and the like. In some embodiments, the surfaces of the sides (20) and (30) are smooth.

The invention further provides a coating pan (50). Referring to FIG. 3, the coating pan (50) comprises a cylindrical surface (52) for receiving a pharmaceutical formulation, an outer wall (54) in contact with one end of the cylindrical surface (52), an inner wall (56) in contact with the other end of the cylindrical surface (52), and at least one baffle (10) as described above. Referring to FIG. 4, the lateral edges (26) and (36) of the sides (20) and (30) of the baffle (10) contact the inner wall (56) or outer wall (54) of the coating pan (50). The bottom edges (24) and (34) of the sides (20) and (30) forming baffle (10) contact the cylindrical surface (52) of the coating pan (50). The coating pan (50) can comprise at least one, at least two, at least three, at least four, at least five, or at least six baffles (10). The baffles (10) can be fastened to the coating pan (50) by any means known to the skilled artisan including, for example, those means described above.

In some embodiments, the single tip of at least one baffle (10) formed by the convergence of the first side tip (28) and the second side tip (38) does not extend the entire width of the cylindrical surface (52). Referring to FIG. 4, this leaves a gap between the convergence of the first side tip (28) and the second side tip (38) and the end of the cylindrical surface (52). In some embodiments, the tip of all baffles (10) formed by the convergence of the first side tip (28) and the second side tip (38) does not extend the entire width of the cylindrical surface (52).

In some embodiments, the gap between the convergence of the first side tip (28) and the second side tip (38) and the end of the cylindrical surface (52) is a distance that is from about 2% to about 50% of the length of the baffle from first side tip (28) and/or second side tip (38) along top edges (22) and/or (32); or from about 2% to about 30% of such length; or from about 2% to about 20% of such length; or from about 2% to about 15% of such length; or from about 10% to about 15% of such length, or from about 12% to about 13% of such length, or from about 2% to about 10% of such length. In some embodiments, the gap is about 12.5% of such length.

Where two or more baffles (10) are present within a coating pan (50), in some embodiments, at least two of the baffles (10) are oriented in the opposite direction to each other. Referring to FIG. 3, the two baffles (10) are oriented such that the lateral edges (26) and (36) of one baffle (10) is contacting the inner wall (56) of the coating pan (50) while the lateral edges (26) and (36) of the other baffle (10) is contacting the outer wall (54) of the coating pan (50). This orientation is also depicted in FIG. 4.

In some embodiments, as depicted in FIG. 4, the flat side (20) of the baffle (10) is aligned perpendicularly with the cylindrical surface (52) of the coating pan (50). In other embodiments, the flat side (20) of the baffle (10) can be aligned at any desired angle with the cylindrical surface (52) of the coating pan (50).

The invention also provides a coating apparatus (not shown) comprising a coating pan (50) described above. Coating apparati are well known to the skilled artisan and are commercially available. Suitable coating apparati include, but are not limited to, a 24″ Comp-U-Lab coater (Thomas Engineering, Inc., Hoffman Estates, Ill.).

The invention further provides methods of manufacturing a baffle (10). For example, a template of the baffle (10), such as a cardboard, wood or plastic template, can be created using the contour of the coating pan (50). A baffle material, such as any of the materials described above, can be cut and shaped according to the template. In some embodiments, the shaping of the baffle (10) can be accomplished using a lathe. The baffles (10) can be fastened by any means to the coating pan (50). In some embodiments, the baffles (10) are screwed to the coating pan (50) through pre-existing perforated bed holes.

The invention further provides methods of coating a pharmaceutical formulation with a coating composition comprising introducing the pharmaceutical formulation and coating composition into any coating pan (50) described herein and rotating the coating pan (50). Preferably the coating composition comprises at least one sugar.

In some embodiments, the plurality of pharmaceutical compositions produced by the method of coating have a cracking rate of less than or equal to about 5%, less than or equal to about 4%, or less than or equal to about 3%. In this context, a plurality refers to one hundred or more pharmaceutical compositions. In this context, the term “about” refers to plus or minus 0.5%. Cracking rate is measured by allowing 100 coated pharmaceutical formulations to slide down a plexiglass tube (one inch I.D.×36 inches at 37 deg.±2 deg.) into a 1 L stainless steel beaker (held at the same angle). This step was repeated four additional times. Subsequently, the coating is examined for the percent of crack.

Pharmaceutical formulations can be conveniently coated in accordance with known procedures using commercially available coating apparati with the coating pans (50) and baffles (10) described herein by employing standard methods and procedures known to those skilled in the art. It will be appreciated that where typical or preferred process conditions are given, other process conditions can also be used unless otherwise stated. Optimum coating conditions may vary with the particular pharmaceutical composition and coating composition, but such conditions can be determined by one skilled in the art by routine optimization procedures. Those skilled in the art of pharmaceutical formulation coatings will recognize that the nature and order of the steps presented may be varied for the purpose of optimizing the coating of the pharmaceutical formulations. For example, a suitable reference for coating pharmaceutical formulations is Introduction to the Coating of Pharmaceutical Oral, Solid-dosage Forms, Stuart C. Porter, Pharmaceutical Unit Processes and Solid Dosage Form Development: Industry and Regulatory Perspectives, May 28, 1997, which is incorporated herein by reference in its entirety.

The baffles described herein can be used to coat various pharmaceutical formulations such as those described in U.S. Provisional Application Ser. No. 60/864,718, filed Nov. 7, 2006, which is incorporated herein by reference in its entirety.

### EXAMPLES

The following describes the coating of representative pharmaceutical formulations of this invention in greater detail. The following examples are offered for illustrative purposes, and are not intended to limit the invention in any manner. Those of skill in the art will readily recognize a variety of noncritical parameters which can be changed or modified to yield essentially the same results.

### Example 1

### Coating Compositions

### Exemplary Coating of Pharmaceutical Formulations Using Baffles Described Herein

Oval biconvex shaped hydrogel-based Premarin tablets with 0.412 inch×0.225 inch×0.034 inch dimension were used for the coating trials. The tablets contain 0.375% of Conjugated Estrogens, 15% Microcrystalline cellulose (Avicel PH 101), 48.51% Lactose Monohydrate Spray Dried, 27.5% HPMC K100M CR, and 0.25% Magnesium Stearate and had an average weight of 120 mg with a related standard deviation in the range of 0.5 to 1.4%. The hardness of tablet cores ranged from 7 to 10 scu.

Several characteristics of the coated pharmaceutical formulation were observed and monitored including, for example, the physical appearance percentage of cracked sugar coats, weight variation (at different weight gains), and content uniformity of MPA of resulting tablets. It was found that tablets coated using baffles designed for film coating or even those traditionally for sugar coating have unacceptable weight variation as well as content uniformity. Different placement of the baffles in the perforate coating pan did not provide improved mixing efficiency. Although a symmetrical V-shaped baffle design may have improved weight variation, because of the nature of the manual sugar coating process, the percentage of cracked sugar coats and broken tablets were far too high to pursue this option. A baffle which is an embodiment of the present invention provided an improved mixing environment since lower weight variations and content uniformity, and fewer damaged tablets were observed. In addition, the physical appearance of the tablets was more elegant. The edges of the tablets rounded faster when using the baffles which are an embodiment of the present invention, and the application process was simplified when compared with that used in other baffle designs. When the baffle which is an embodiment of the present invention was scaled up to GCX-1000 it as well demonstrated a superior mixing efficiency compared to the traditional sugar and film coating baffles.

TABLE 1
Composition of Filler Coating Suspension

| | Input/Tablet |
|---|---|
| Description | (mg) |
| Premarin 0.45 mg tablet core | 120.0 |
| Medroxyprogesterone Acetate | 1.59 |
| (MPA), USP, Micronized @100% | |
| (A) | |
| Sucrose, NF | 96.672 |
| Microcrystalline Cellulose, NF | 0.53 |
| Sodium Lauryl Sulfate, NF | 0.318 |
| Polyethylene Glycol 400, NF | 1.06 |
| Povidone K25, USP | 5.3 |
| Cab-O-Sil, NF | 0.53 |
| Water, USP, Purified (B) | 70.67 |

(A) Indicates that the potency of the Medroxyprogesterone Acetate, USP, Micronized 100% may vary and the amount in the formulation must be adjusted accordingly. If the amount of MPA is adjusted, the amount of Sucrose will be adjusted accordingly. A 6% overage is included to compensate for the manufacturing loss during coating.
(B) Indicates removed during processing.

TABLE 2
Composition of Color Coating Suspension

| Description | Input/Tablet (mg) |
|---|---|
| Premarin/MPA | 226 |
| (0.45/1.5 mg) Filled | |
| Tablet | |
| Sucrose, NF | 23.4904 |
| Titanium Dioxide, | 0.7692 |
| USP | |
| Povidone K25, USP | 0.6154 |
| Cab-O-Sil, NF | 0.1250 |
| Water, USP, | 13.4615 |
| Purified (A) | |

(A) Indicates removed during processing.

TABLE 3
Composition of Polishing Suspension

| Description | Input/Tablet (mg) |
|---|---|
| Premarin/MPA (0.45/1.5 mg) | 251 |
| colored Tablet | |
| Carnauba Wax, NF, | 0.222 |
| #120 | |
| Mineral Spirits, | 0.469 |
| Odorless (A) | |

(A) Indicates removed during processing.

### Example 2

### Manufacturing Process

### MPA Filler Suspensions Preparation

The MPA filler suspensions were prepared using following steps:

1) Add water, purified in an appropriately sized jacketed container; while mixing with a high shear mixer, heat the water to 65° C.±5° C. and add the sucrose; reheat to 65° C.; mix until all the sucrose is dissolved.

2) Cool the above solution to 40-45° C.; slowly add to the vortex using a high shear mixer, the Polyethylene Glycol, Povidone K25, Microcrystalline Cellulose, and Cab-O-Sil; mix above solution for another 1 minute using a high shear mixer.

3) While mixing with the high shear mixer, cool the above suspension to 35-39° C. and slowly add Sodium Lauryl Sulfate and MPA.

4) Mix continuously using a low shear mixer, while maintaining the tank temperature at 35° C. to 39° C. during the entire application process.

### MPA Filler Suspension Application When Using Comp-U-Lab Coater

1) To the 24″ perforated coating pan with the different designed baffles, load approximately 33,333 hydrogel Premarin tablet cores.

2) Set inlet temperature at 40° C. and inlet airflow at 75 cfm; preheat the tablets to about 30° C., dew point 11° C. and exhaust temperature at 35° C.

3) With the pan rotating at 18 rpm, apply incremental shots of MPA filler suspension by a syringe until an average tablet weight gain of 106 mg is achieved; each shot is followed by a tumbling jog cycle of 180-300 seconds (no air through the coating pan) followed by a drying phase of 60-180 seconds.

### MPA Filler Suspension Application When Scale-up to GCX-1000

1) To the GCX-1000 coater pan with the different designed baffles, load approximately 166,666 hydrogel Premarin tablet cores.

2) Set inlet temperature at 35° C. and inlet airflow at 250 cfm; preheat the tablets to about 30° C., dew point 12° C. and exhaust temperature at 30° C.

3) Mount two Graco guns at equal distance on the boom; install hydraulic nozzles (Spraying Systems 11001-SS tips) onto the Graco guns; connect a Graco pump (piston pump) to the suspension supply line; adjust the suspension spray pressure at a pressure of 80-100 psi in order to produce a fan shape spray that covers the entire tablet bed; with the pan rotating at 10 rpm, spray incremental shots of MPA filler suspension until an average tablet weight gain of 106 mg is achieved; each shot is followed by a tumbling jog cycle of 180-300 seconds (no air through the coating pan) followed by a drying phase of 60-180 seconds.

### Color Suspensions Preparation

1) Add Water, purified in an appropriately sized jacketed container; while mixing with a high shear mixer, heat the water to 65° C.±5° C. and add the Sucrose; reheat to 65° C.; continue stirring until all the sucrose is dissolved.

2) Add the Povidone and Titanium Dioxide; mix using a high shear mixer to insure homogeneous suspension.

3) Add Cab-O-Sil and mix using a high shear mixer to make a homogeneous suspension.

4) Cool the suspension to 35-39° C.

5) Mix continuously using the low shear mixer, while maintaining the tank temperature at 35° C. to 39° C. during the entire application process.

### Color Suspension Application

1) To a 24″ perforated coating pan installed in the Comp-U-Lab coater with the special designed baffles, load approximately 33,333 Premarin/MPA filled tablets.

2) Set inlet temperature at 40° C. and inlet airflow at 75 cfm; preheat the tablets to about 30° C. dew point 11° C. and exhaust temperature at 35° C.

3) With the pan rotating at 18 rpm, apply incremental shots of color suspension until an average tablet weight gain of 25 mg is achieved; each shot is followed by a tumbling jog cycle of 180-300 seconds (no air through the coating pan) followed by a drying phase of 60-180 seconds.

### Preparation and Application of Polish

1) Prepare the polish suspension by suspending the Carnauba Wax, NF #120 in the Mineral Spirits, Odorless with vigorous stirring.

2) Apply the polish suspension to the rolling tablets; continue rolling until a satisfactory gloss is obtained.

### Example 3

### Baffle Designs

Table 4 lists all the properties of the baffles evaluated in this study.

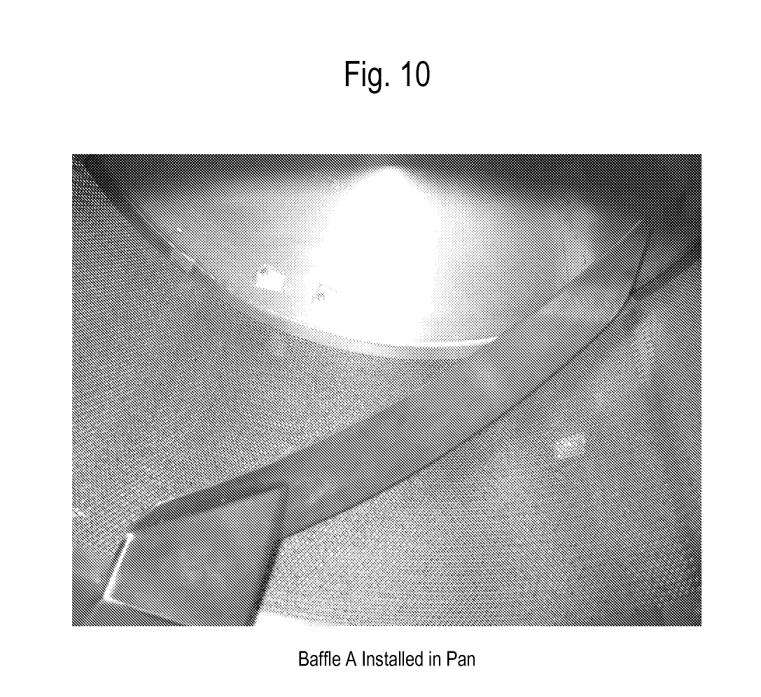

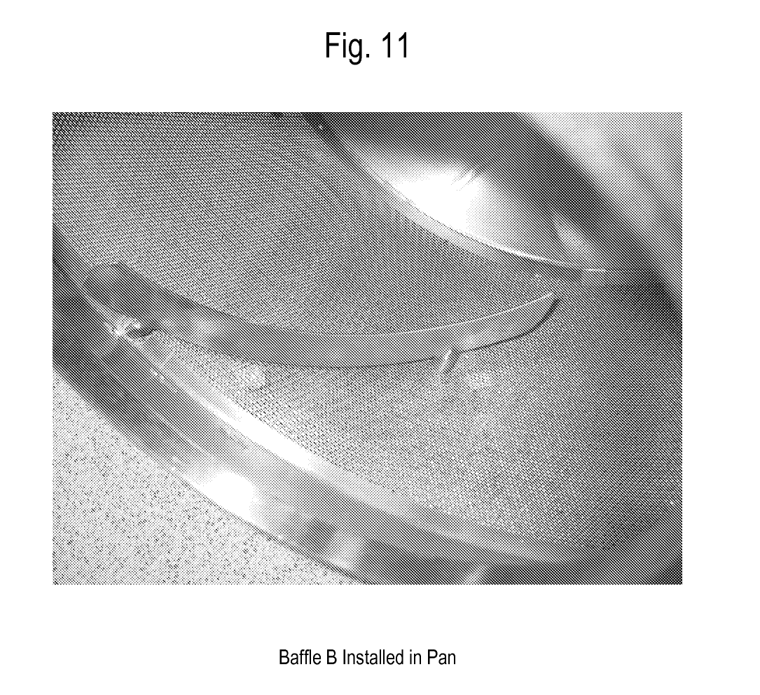

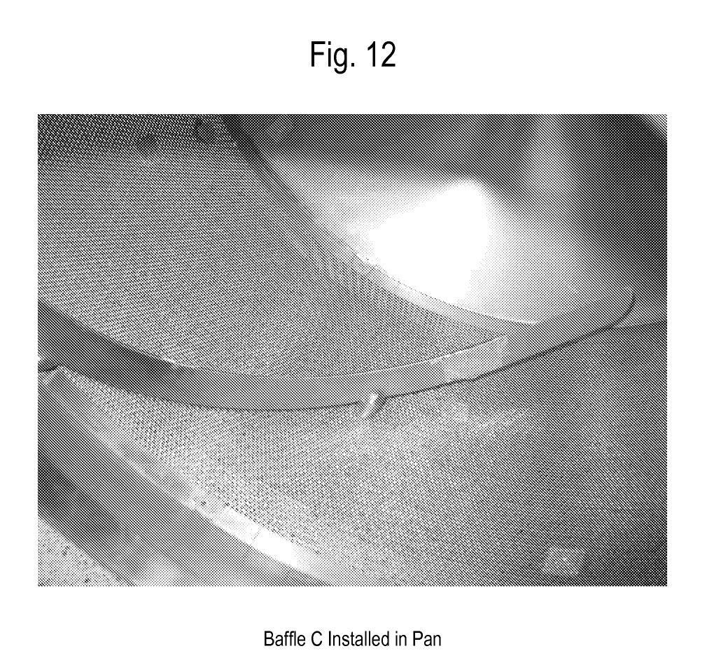

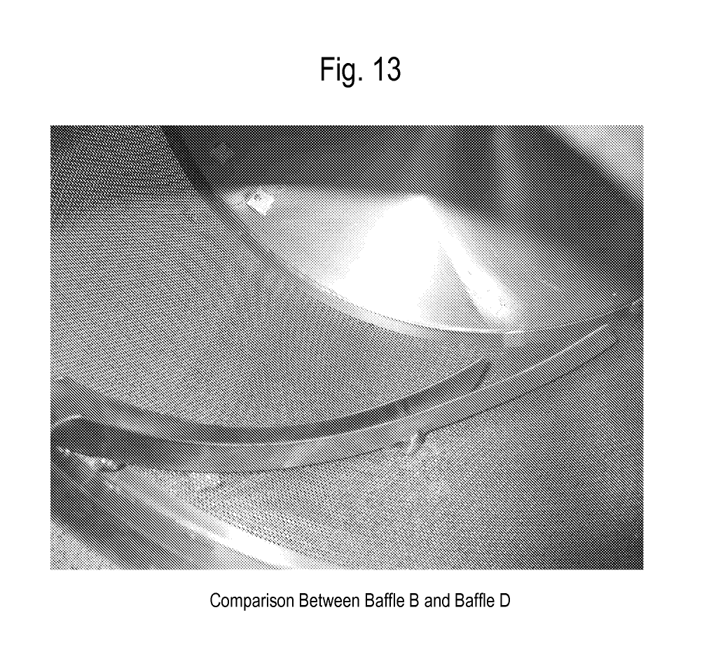

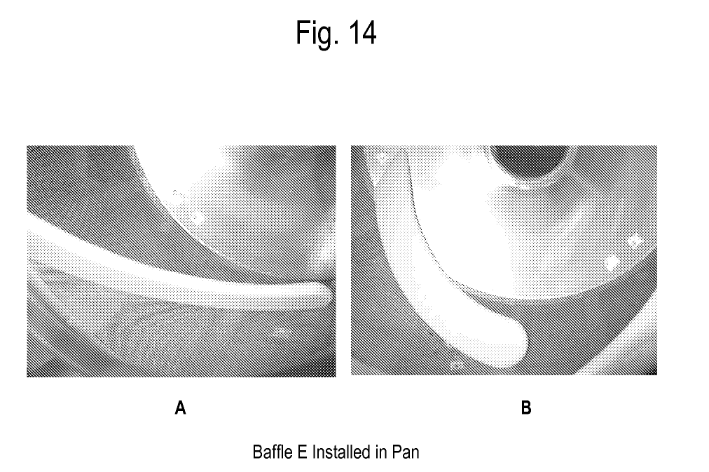

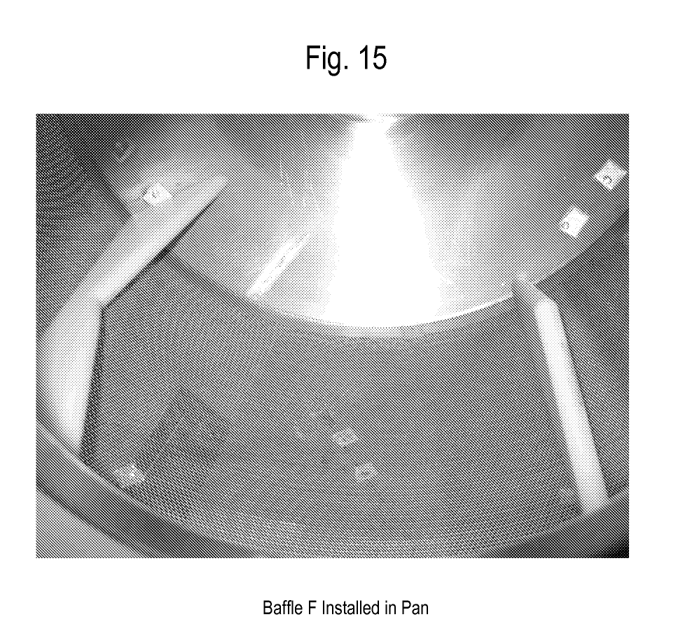

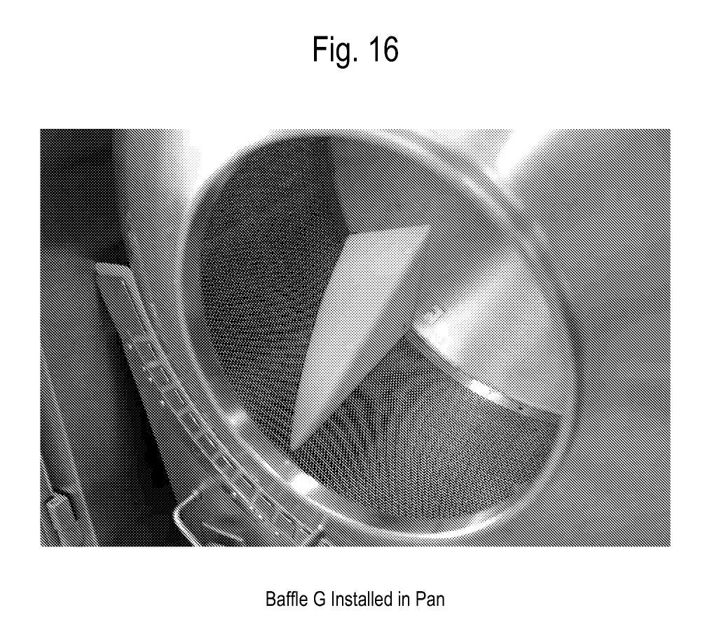

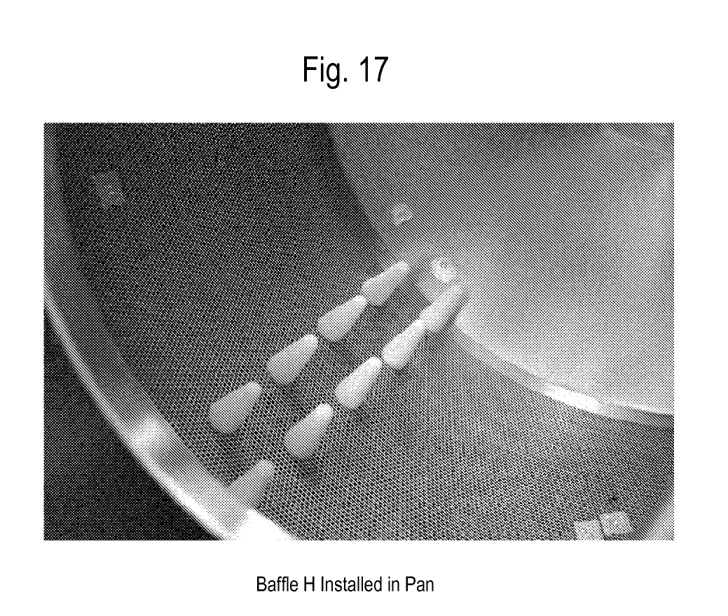

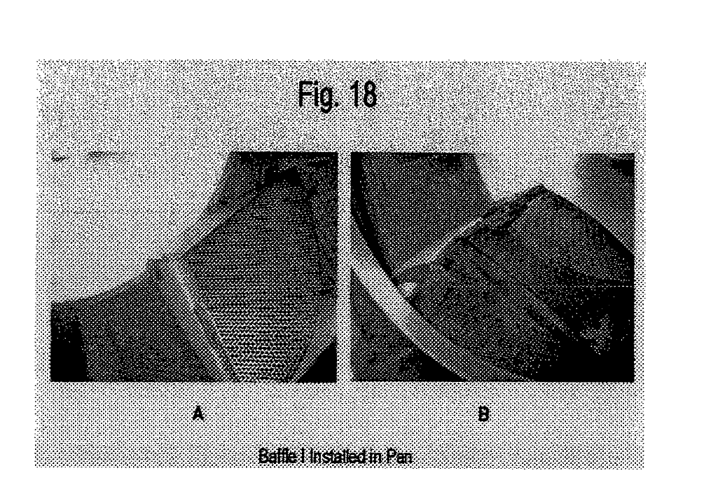

TABLE 4
Baffle Descriptions

| Baffle | |
|---|---|
| Designation | Properties |
| A (FIG. 10) | Metal, 20¼″ long. Three were installed from front to |
| (Comparison) | back of the pan. |
| B (FIG. 11) | Metal, 15″ regular sugar coating baffles. Three were |
| (Comparison) | installed from front to back of the pan. |
| C (FIG. 12) | Metal, Baffle B + 6.5″ extension. Three were installed |
| (Comparison) | from front to back of the pan. |
| D (FIG. 13) | Metal, 19″ long. Three were installed from front to back |
| (Comparison) | of the pan. |
| E (FIG. 14) | Plastic, two from front to back, one from back to front |
| (Comparison) | in the same direction as the other two. |
| F (FIG. 15) | Plastic, V-shaped baffles, two with convex V and two |
| (Comparison) | with concave V were installed alternatively. |
| G (FIG. 16) | Plasticbaffles, four were used, with two from front to |
| (Embodiment | back and two from back to front installed alternatively. |
| of the | |
| invention) | |
| H (FIG. 17) | Plastic, Spike shaped, four groups were installed. Each |
| (Comparison) | group has 9 spikes, with 4 in the front and 5 in the back. |
| I (FIG. 18) | Baffle F plus perforated extension. |
| (Comparison) | |

Baffle A is primarily used for film coating.

Baffle B is a sugar coating baffle. Since the Baffle B did not extend from the front to the back of the pan, it was questionable whether there were dead zones at the back of the pan during mixing.

A handmade extension of 6.5″ was attached to the Baffle B (Baffle C). This leads the design of Baffle D.

The purpose of Baffle E was to evaluate whether the installation configuration had any contributing influence on the uniformity of mixing.

Since Baffle A through E all generated non-symmetrical patterns of tablet distribution in the pan, Baffle F was designed in an attempt to obtain a balanced distribution of tablets in the back of the pan during mixing.

Baffle G (see FIGS. 1 and 2 herein) is an embodiment of the present invention The edge (22/32) formed by the joining of the respective top edges of the first side and second side is rounded to enable tablets to roll more smoothly over the baffle.

This design prevented wetted tablets from sticking underneath the baffles during coating as was observed with Baffles A-F. The installation configuration of Baffle G (see FIGS. 3 and 4 herein) in the pan can also effectively prevent dead zones since the baffles force tablets to travel from back to front and vice versa during mixing.

Baffle H was designed to provide less resistance to the tablet flow and allow the tablets to experience maximum contact with each other when passing through the spaces between each spike. Another advantage of this unique design was that all the spikes could be re-configured for additional experiments. This would allow better distribution of the coating material from tablet to tablet and consequently produce a more uniform surface.

Baffle I was generated as an improvement of Baffle F. During the coating using Baffle F, it was observed that there were tablets sticking behind the baffles. In order to reduce the sticking, a perforated extension was installed at the back of each baffle.

### Example 4

### Mixing Efficiency Study Using Comp-U-Lab 24

The mixing efficiency study was carried out by charging the pan with three equal weights of different color tablets. Purple tablets were placed at the front position of the pan, white tablets were placed at the center, and pink tablets were at the back of the coating pan. Coating suspension was applied with the aid of a syringe to the cascading tablet bed. After one tumbling jog and dry cycle, the pan was stopped and 100 tablets were collected from front, center, and back positions of the pan. The distribution of each color tablet at these three positions in the pan was calculated by counting number of tablets of each color. The pan was restarted again, and another shot of coating suspension was applied with a tumbling jog and dry cycle. The distribution after the second shot application was calculated. This exercise was repeated for one more shot application and the distribution was calculated.

The mixing efficiency study was carried out using Baffles B, E, F, and G, respectively. From the data showed in Tables 5, 6, 7 and 8 it can be seen that use of Baffles B, F and G resulted in close to a uniform distribution even after the first shot. However, in the case of Baffle E, the tablets are not uniformly mixed at the back of the pan even after three shots. Thus, this type of baffle alignment does not provide efficient mixing.

TABLE 5
Results of Mixing Efficiency Study on Baffle B

Pan Position

| Shot # | Front | Center | Back |
|---|---|---|---|
| 0 | 100% Purple | 100% White | 100% Pink |
| 1 | 31% Purple | 31% Purple | 34% Purple |
| | 34% White | 34% White | 38% White |
| | 35% Pink | 35% Pink | 28% Pink |
| 2 | 32% Purple | 26% Purple | 28% Purple |
| | 31% White | 41% White | 36% White |
| | 37% Pink | 33% Pink | 36% Pink |
| 3 | 39% Purple | 33% Purple | 30% Purple |
| | 32% White | 35% White | 35% White |
| | 29% Pink | 32% Pink | 35% Pink |

TABLE 6
Results of Mixing Efficiency Study on Baffle E (Two Baffles
from Front to Back, One Baffle from Back to Front in the Same
Direction as the Other Two)

Pan Position

| Shot # | Front | Center | Back |
|---|---|---|---|
| 0 | 100% Purple | 100% White | 100% Pink |
| 1 | 30% Purple | 32% Purple | 24% Purple |
| | 34% White | 31% White | 41% White |
| | 36% Pink | 37% Pink | 35% Pink |
| 2 | 30% Purple | 29% Purple | 23% Purple |
| | 36% White | 33% White | 43% White |
| | 34% Pink | 38% Pink | 34% Pink |
| 3 | 30% Purple | 23% Purple | 22% Purple |
| | 42% White | 38% White | 34% White |
| | 28% Pink | 39% Pink | 44% Pink |

TABLE 7
Results of Mixing Efficiency Study on Baffle F

Pan Position

| Shot # | Front | Center | Back |
|---|---|---|---|
| 0 | 100% Purple | 100% White | 100% Pink |
| 1 | 36% Purple | 32% Purple | 29% Purple |
| | 34% White | 30% White | 35% White |
| | 30% Pink | 38% Pink | 36% Pink |
| 2 | 29% Purple | 25% Purple | 34% Purple |
| | 33% White | 39% White | 33% White |
| | 38% Pink | 36% Pink | 33% Pink |
| 3 | 28% Purple | 29% Purple | 36% Purple |
| | 41% White | 39% White | 32% White |
| | 31% Pink | 32% Pink | 32% Pink |

TABLE 8
Results of Mixing Efficiency Study on Baffle G

Pan Position

| Shot # | Front | Center | Back |
|---|---|---|---|
| 0 | 100% Purple | 100% White | 100% Pink |
| 1 | 33% Purple | 33% Purple | 34% Purple |
| | 37% White | 28% White | 34% White |
| | 30% Pink | 39% Pink | 32% Pink |
| 2 | 29% Purple | 35% Purple | 34% Purple |
| | 37% White | 32% White | 31% White |
| | 34% Pink | 33% Pink | 35% Pink |
| 3 | 37% Purple | 39% Purple | 32% Purple |
| | 28% White | 28% White | 35% White |
| | 35% Pink | 33% Pink | 33% Pink |

### Example 5

### Physical Appearance Evaluation

The physical appearance of tablets was examined by observing the surface of the tablets visually, or with magnifying glasses, for surface anomalies during the coating run. In most cases, sugar coating is intended to improve the appearance of the tablets. The quality of any subsequent color and polishing processes is highly dependent upon the uniformity of the substrate filler coat. Thus, it is important to ensure that filled tablets are not cracked or chipped.

The physical appearance and percentage of cracked tablets of the batches manufactured with the different baffles was evaluated. The results are presented in Table 9. Tablets coated using Baffle F resulted in a high percent of cracked tablets. In addition, the appearance of the coated tablets is poor. On the other hand, Baffle G produced tablets of elegant appearance and low percentage of cracked tablets. During the coating process when using Baffle F, it was observed that the wetted tablets fell onto the bottom of the coating pan from the “shelf-effect” generated by the baffles. The “shelf-effect” was caused by the shape and angle of the baffles to the pan. The wetted tablets were held by the baffles and brought up to the top of the pan. This “shelf-effect” produced an unusual amount of broken tablets. In addition, the wetted tablets constantly stuck to the back of the baffles. In the case of Baffle G, the wetted tablets rolled instead of falling onto the bottom of the pan. There were no sticking issues during the entire coating process and this might have contributed to the good appearance and strong coating (less cracking and broken tablets). Even though Baffle H can provide tablets with a good appearance, there was a great amount of sugar crystal build-up on the tips of baffles during the coating process. The tablets coated using this baffle exhibit a high cracking percentage. With Baffle I, the sticking issues observed with Baffle F were resolved. However, the tablets still fell instead of rolled onto the bottom of the coating pan since the “shelf-effect” still existed. Therefore, this baffle produces a high percentage of cracked and brittle tablets.

TABLE 9
Physical Appearance, Cracking Rate, and Weight Variation of
Tablets Coated Using Different Baffles at 106 mg Targeted Weight Gain

| | Baffle | Physical | Cracking Rate | Wt Variation |
|---|---|---|---|---|
| Experiment # | Type | Appearance | (%) | (%) |
| Batch 10 | F | Rough Surface | 32 | 1.49 |
| Batch 13 | G | Excellent | 3 | 2.26 |
| Batch 15 | H | Excellent | 60 | 2.86 |
| Batch 16 | I | Excellent | 55 | 3.52 |

### Example 6

### Tablet Cracking Percentage

Coated tablets were allowed to slide down a tube into a stainless steel beaker. This process was repeated four times. Subsequently, the sugar coatings were examined for the percent of crack. The results are reported in Table 9 above.

### Example 7

### Weight Variation Study at Different Coating Stages Using Comp-U-Lab 24

Samples of approximately 100 tablets were taken at different weight gains during the course of coating. Weight variation of 100 tablets was evaluated using Mocon Automatic Balance Analysis tester (Modern Controls, Inc., Minneapolis, Minn.).

The weight variation testing was performed at 25%, 50%, 75%, and 100% targeted weight gain levels when using Baffle A, C, D, and E. The weight variation of the batch coated using Baffle B was only evaluated at 100% targeted weight gain level.

Baffle A was not efficient in providing low weight variation of sugar coating. At 100% application, the weight variation coefficient of variation was close to 5%. Baffle C, with the handmade extension, was even less efficient since it generated the highest weight variations. Baffle D, which was made by increasing the length of Baffle B, did not improve the mixing efficiency as there is no improvement in weight variation when comparing the use of Baffle B or D at 100% weight gain.

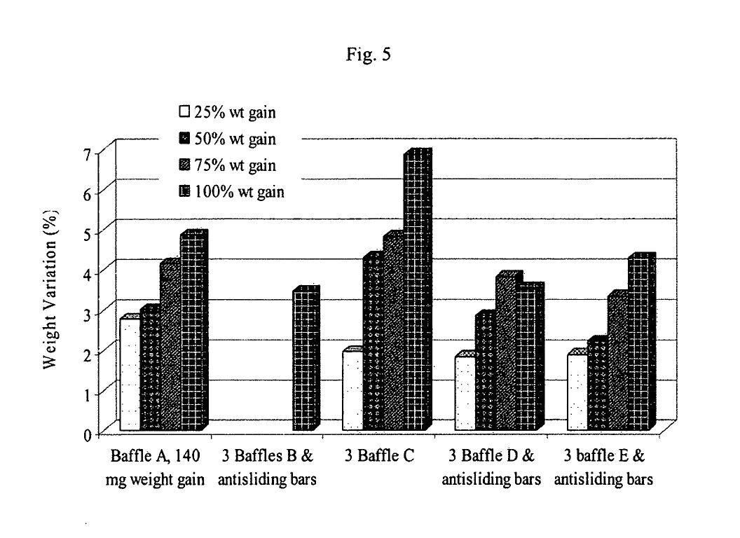

In the case of Baffle E, one of the baffles was installed from back to front of the pan in the same directions as the other two baffles. This alignment provided a different pattern of tablet movement in the pan. It was observed that the tablets had a tendency to stay at the back of the pan at most of the times during coating. As indicated in FIG. 5, the weight variation from this experiment was not significantly different from the experiment with Baffle B. Therefore, this design could not provide an advantage for improving the mixing uniformity. It appears that wetted tablets have to travel from the back to front and vice versa in the coating pan in order to produce a uniform mixing thus providing the lowest possible RSD for weight variation.

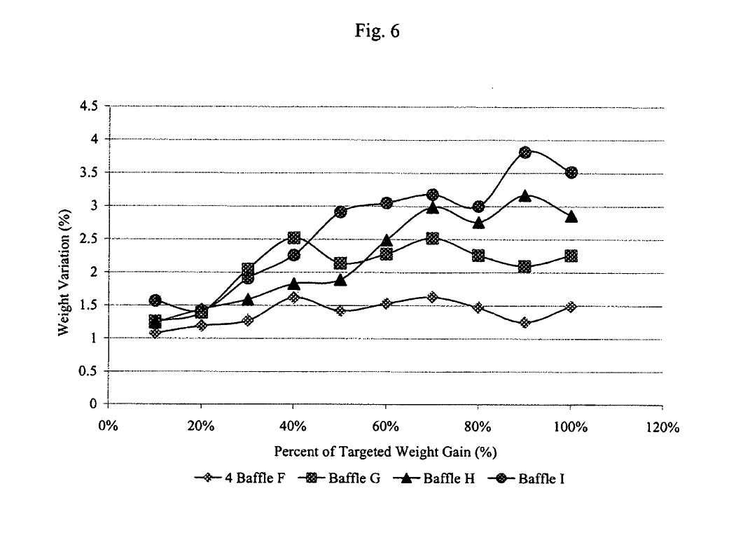

The results of studies on Baffles F, G, H and I are displayed in FIG. 6. It is evident that Baffle F provides the lowest of most consistent weight variation among these four types of designs. Baffle G is better than both Baffle H and Baffle I in providing an acceptable weight variation. The perforated extensions of Baffle F, used to produce Baffle I, did not provide any advantages in the respects to weight variation.

### Example 8

### Content Uniformity Evaluation

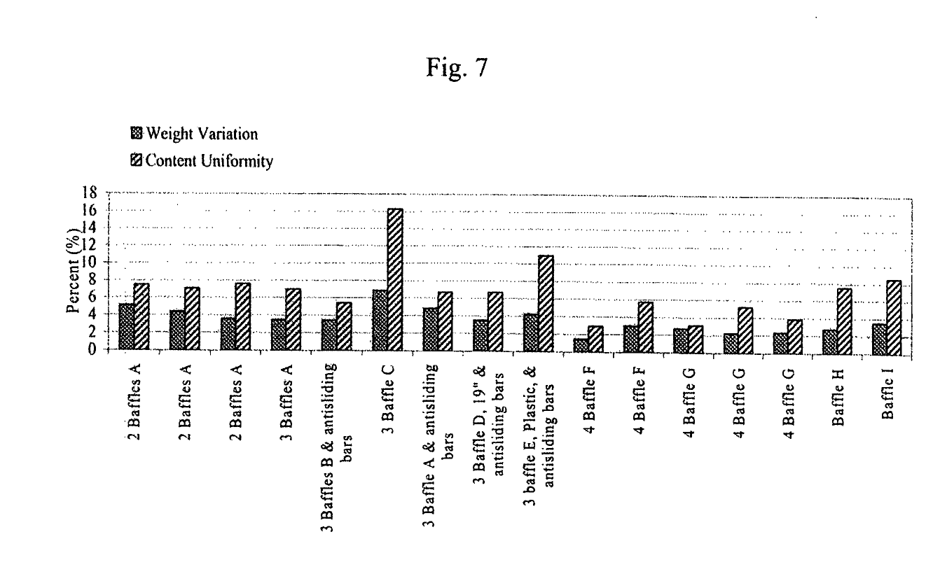

Content uniformity of MPA was measured upon completion of the coating processes in the 24″ coater. FIG. 7 displays the results. The results concluded that Baffles G and F produced tablets with better content uniformity for MPA as compared to the others. Baffle F, however, would not produce an elegant tablet as demonstrated with Baffle G.

### Example 9

### Edge Rounding Rate Comparison

The edge rounding rate is another important factor in the sugar coating process since it may determine the length of the coating process, outcome of final batch appearance, percentage of cracked tablets and dissolution variability. Because of the characteristics of sugar coating, the surface of the tablets is easier to cover with the coating solution/suspension than the edges. The longer it takes to round off the tablet edges, the longer the sugar coating process will be. There are several factors influencing the edge rounding rate, however, the pan mixing mechanism, which determines how the tablets move, is one of the most important factors. The edge rounding rate obtained with certain baffle was investigated by taking pictures of a tablet coated at 30% weight gain level. The presence of a rounded tablet edge at this weight gain level signifies a rapid rounding rate and efficient mixing.

When Baffles F, G and H were used for coating tablets at 30% targeted weight gain level (32 mg), the edges of the tablets coated using Baffle G were rounded while those produced using Baffle F and Baffle H batches still required more processing time. Thus, the edge rounding rate achieved with Baffle G was faster than that with Baffles F and H, because Baffle G design can provide more efficient mixing.

### Example 10

### Scale-Up to GCX-1000

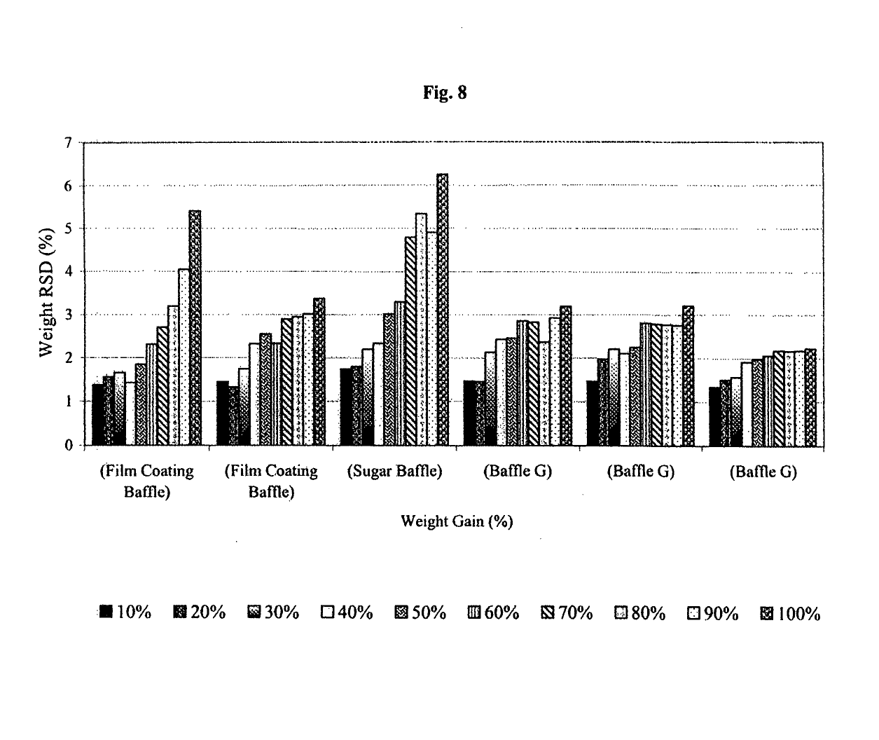

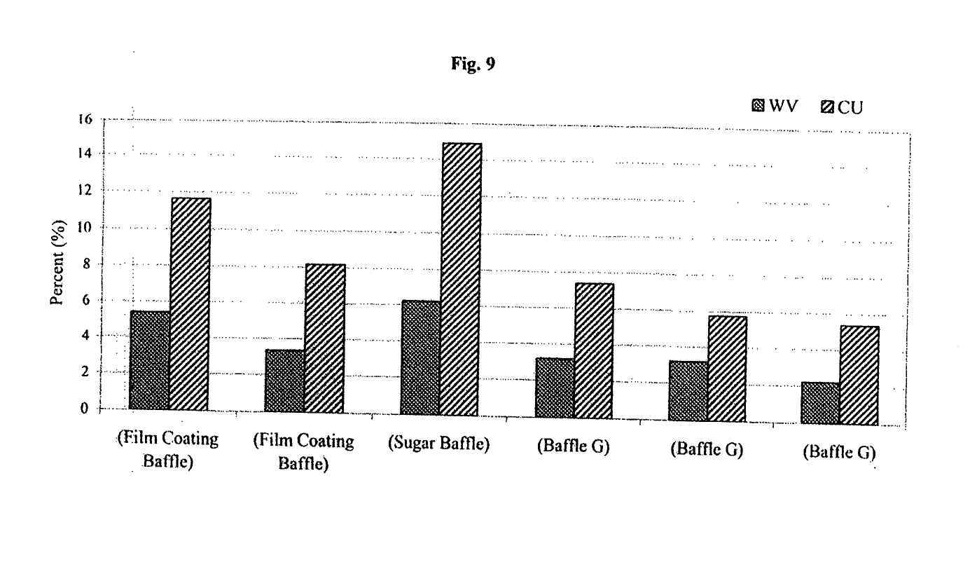

The filler coat process was scaled-up to GCX-1000 batch size. Different baffle designs, which included regular film coating and sugar coating baffles as well as scaled-up Baffle G, were evaluated. Tablet weight variation at different coating stages was measured using the same evaluation methodology in Comp-U-Lab 24″ scale. In addition, content uniformity of MPA was determined. FIG. 8 shows the tablet weight variation at different coating stages and FIG. 9 displays the results for MPA content uniformity. These results confirm the more efficient mixing of Baffle C in a larger scale.

When evaluating from all aspects for sugar coating in the current study, Baffle G which is an embodiment of the present invention provided tablets with excellent appearance, faster edge rounding rate, lower cracking rate, and lower weight variation as well as content uniformity. Baffle G demonstrated good mixing capabilities so that dead spots were effectively avoided at current studies at small as well as large scale.

It is intended that each of the patents, applications, and printed publications including books mentioned in this patent document be hereby incorporated by reference in their entirety.

As those skilled in the art will appreciate, numerous changes and modifications may be made to the preferred embodiments of the invention without departing from the spirit of the invention. It is intended that all such variations fall within the scope of the invention.

What is claimed is:

1. A baffle comprising:
a first side comprising a top edge, a bottom edge, and a lateral edge, wherein said first side is flat, and wherein said top edge and said bottom edge converge to form a first side tip distal to said lateral edge; and
a second side comprising a top edge, a bottom edge, and a lateral edge, wherein said second side is curved, and wherein said top edge and said bottom edge converge to form a second side tip distal to said lateral edge;
wherein said first side and said second side are joined at each of said top edges, and wherein joining of said first and second sides forms an internal angle of no less than about 45° to no greater than about 120°, and wherein said first side tip and said second side tip converge to form a single tip.

2. The baffle of claim 1, wherein said internal angle is no less than about 60° and no greater than about 105°.

3. The baffle of claim 1, wherein said internal angle is no less than about 75° and no greater than about 100°.

4. The baffle of claim 1, wherein said internal angle is about 90°.

5. The baffle of claim 1, wherein said first side and second side are joined seamlessly at said top edges.

6. A coating pan comprising:
a cylindrical surface for receiving a pharmaceutical formulation;
an outer wall in contact with one end of said cylindrical surface;
an inner wall in contact with the other end of said cylindrical surface; and
at least one baffle of claim 1, wherein said lateral edges of said sides forming said baffle contact said inner or outer wall of said coating pan, and said bottom edges of said sides forming said baffle contact said cylindrical surface of said coating pan.

7. The coating pan of claim 6, wherein said single tip of said at least one baffle does not extend the entire width of said cylindrical surface.

8. The coating pan of claim 6, further comprising at least a second baffle of claim 1, wherein said single tip of said at least a second baffle does not extend the entire width of said cylindrical surface.

9. The coating pan of claim 8, wherein at least two of said baffles are oriented in the opposite direction to each other.

10. A coating apparatus comprising a coating pan of claim 6.

11. A method of manufacturing a baffle of claim 1 comprising creating a template of said baffle, and cutting and shaping a baffle material based upon said template.

12. The method of claim 11, wherein the baffle material is polytetrafluoroethylene.

13. A method of coating a pharmaceutical formulation comprising introducing said pharmaceutical formulation and a coating composition into a coating pan of claim 6; and rotating said coating pan.

14. The method of claim 13, wherein the coating composition comprises at least one sugar.

15. A baffle substantially as shown in any of FIG. 1, 2, 3, or 16.

16. A coating pan comprising:
a cylindrical surface for receiving a pharmaceutical formulation;
an outer wall in contact with one end of said cylindrical surface;
an inner wall in contact with the other end of said cylindrical surface, and
at least one baffle substantially as shown in any of FIG. 1, 2, 3, or 16.

17. A coating pan of claim 16, comprising at least four of said baffles, wherein adjacent baffles are oriented in the opposite direction relative to each other.

18. A method of coating a pharmaceutical formulation comprising introducing said pharmaceutical formulation and a coating composition into a coating pan of claim 17; and rotating said coating pan.

19. The method of claim 18, wherein the coating composition comprises at least one sugar.
